(19) United States
(12) Patent Application Publication
(10) Pub. No.: US 2002/0142677 A1
(43) Pub. Date: Oct. 3, 2002

(54) Electric connecting device and electric connector using resin solder and method of connecting electric wire to them

(75) Inventors: Taiji Hosaka, Yokohama-shi (JP); Masaaki Miyazawa, Kawasaki-shi (JP)

Correspondence Address: FASSE PATENT ATTORNEYS, P.A., P.O. BOX 726, HAMPDEN, ME, 04444-0726, US

(73) Assignee: J.S.T. Mfg. Co., Ltd., Osaka-shi (JP)

(21) Appl. No.: 10/114,799

(22) Filed: Apr. 1, 2002

(30) Foreign Application Priority Data
Mar. 30, 2001 (JP) 2001-102644

(51) Int. Cl. H01R 4/02

(52) U.S. Cl. 439/874

(57) ABSTRACT

The objectives of the present invention include to connect an electric wire to the electric connecting device without soldering work and to connect a very fine wire to the electric connecting device by means of an automatic machine.

The electric connecting device according to the present invention comprises a first connecting part which couples with a counterpart member or fits with a counterpart member, and a second connecting part to which the conductor of an electric wire is connected. In this electric connecting device, at least a part of the second connecting part to which the conductor of the electric wire is connected is made of a led-free ultrahigh-conductive plastic being a conductive resin composite.

### BACKGROUND OF THE INVENTION

1. Field of the Invention

The present invention belongs to a field of electric connecting devices such as terminals, contacts and piercing contact elements, which are connected to an electric wire and coupled with a counterpart member or fitted with a counterpart member, and of electric connectors that use such electric connecting devices, and relates to an electric connecting device and an electric connector that use a lead-free ultrahigh-conductive plastic comprising a conductive resin composite.

2. Related Art

Methods of connecting an electric wire to an electric connecting device such as a terminal, contact or piercing contact element include the method by soldering, the method by piercing, the method by crimping and the method by insulation displacement contact. In the case of piercing, the electric connecting device is provided with a piercing part, and this piercing part is made to pierce the electric wire till the piercing part reaches the conductor of the electric wire to connect the electric wire to the electric connecting device. In the case of crimping, the electric connecting device is provided with a barrel, and the barrel is crimped to the electric wire to connect the electric wire to the electric connecting device. In the case of insulation displacement contact, the electric connecting device is provided with a slot, and the electric wire is pressed into this slot to make the slot displace the insulation and make the conductor contact the slot to connect the electric wire to the electric connecting device.

When an electric wire is to be connected to an electric connecting device by soldering, the conductor of the electric wire will be placed on the electric connecting device and molten solder will be applied to them. However, if the electric wire is to be soldered to, for example, a recess in the electric connecting device, it will be difficult or impossible to do so. Moreover, the work of applying solder requires delicate quality control of solder, temperature control and the like, and in turn increases the control man-hour.

When the connection is effected by piercing, crimping or insulation displacement contact, the connection strength by any of these methods is inferior to that of soldering because the electric wire is held on the electric connecting device by a fitting force or the like.

When the electric wire is a very fine wire (for example, American Wire Gauge size 36 falls in the category of very fine wire, and the diameter of this electric wire is 0.12 mm approximately.), the work of applying molten solder to the contacting parts of both the conductor of the electric wire and the electric connecting device can not be done by an automatic machine, and it is inevitable to do the work manually by a skilled worker. Hence the productivity is low and this results in an increase in cost. Similar problems are also encountered when a very fine electric wire is connected to an electric connecting device by piercing, crimping or insulation displacement contact. In particular, when a very fine wire is to be connected to an electric connecting device by piercing, as the conductor is thin, the strength to hold the piercing part of the electric connecting device on the electric wire is weak, and the connection strength is low and in turn the reliability is low.

Japanese Patent unexamined publication gazette Heisei 10-237331 discloses a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

### SUMMARY OF THE INVENTION

This lead-free ultrahigh-conductive plastic exhibits a high conductivity, for example, 10⁻³ Ω·cm or under in volume resistivity. Moreover, this material can be formed by injection molding and has a high degree of formability. As this material contains solder, there is no need of separately applying solder. One objective of the present invention is to provide an electric connecting device that can solve the above-mentioned problems by using the lead-free ultrahigh-conductive plastic that has such excellent conductivity and formability and contains solder.

To accomplish the above-mentioned objective, an electric connecting device using resin solder having conductivity according to the present invention comprises a first connecting part which couples with a counterpart member or fits with a counterpart member, and a second connecting part to which a conductor of an electric wire is connected, and at least a part of the second connecting part to which the conductor of the electric wire is connected is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

When the conductor of the electric wire is placed on the part of the second connecting part of the electric connecting device to be connected to the conductor of the electric wire and the contacting parts of both the former and the latter are heated, the lead-free solder, which is contained in the lead-free ultrahigh-conductive plastic of this part, will melt out and stick to the conductor of the electric wire. When the solder cools and solidifies, the conductor of the electric wire will be connected to the electric connecting device. Then, the electric connecting device will be coupled with a counterpart member or fitted with a counterpart member by the first connecting part. Accordingly, the work of separately applying solder is not required. Hence the electric wire can be easily connected to a part that is difficult or impossible to be soldered, such as a recess of the electric connecting device. Moreover, as quality control, temperature control and the like of the solder are not required, the control man-hour will be reduced correspondingly. Furthermore, connection of a very fine wire can be made by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric connecting device can be reduced. After connection of the electric wire, when electricity is passed at a normal level, the lead-free ultrahigh-conductive plastic will not melt due to heat generation. In comparison with the technology of MID (Molded Interconnection Device; for example, refer to Utility Model Gazette No. 2597015) wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding. Hence each part to be made of the lead-free ultrahigh-conductive plastic can be molded to a variety of configurations according to the application. This makes it easier to obtain impedance matching. When only a part of the electric connecting device is to be made of the lead-free ultrahigh-conductive plastic, if the other part is made of a material that has a higher strength and a higher elasticity than those of the lead-free ultrahigh-conductive plastic, such as a metal, the strength and the elasticity of the electric connecting device, in particular, those of the first connecting part will be enhanced.

### BRIEF DESCRIPTION OF THE DRAWINGS

FIG. 1 is a perspective view of the first embodiment of the electric connecting device according to the present invention.

FIG. 2 is a sectional view of the first embodiment of the electric connecting device.

FIG. 3 is a sectional view of the first embodiment of the electric connecting device with an electric wire connected to it.

FIG. 4 is a schematic diagram showing another embodiment of the method of connecting an electric wire to the first embodiment of the electric connecting device.

FIG. 5 is a perspective view of the second embodiment of the electric connecting device.

FIG. 6 is a sectional view of the second embodiment of the electric connecting device.

FIG. 7 is a sectional view of the second embodiment of the electric connecting device with an electric wire connected to it.

FIG. 8 is a perspective view of the third embodiment of the electric connecting device.

FIG. 9 is a sectional view showing the state of use of the third embodiment of the electric connecting device.

FIG. 10 is a perspective view of the fourth embodiment of the electric connecting device.

FIG. 11 is a perspective view of the fifth embodiment of the electric connecting device.

FIG. 12 is a perspective view of the sixth embodiment of the electric connecting device.

FIG. 13 is a perspective view of the seventh embodiment of the electric connecting device.

FIG. 14 is sectional view of the seventh embodiment of the electric connecting device.

FIG. 15 is a perspective view of the eighth embodiment of the electric connecting device.

FIG. 16 is a perspective view of the ninth embodiment of the electric connecting device.

FIG. 17 is a sectional view of the ninth embodiment of the electric connecting device.

FIG. 18 is a perspective view of the tenth embodiment of the electric connecting device.

FIG. 19 is a perspective view showing the state of use of the tenth embodiment of the electric connecting device.

FIG. 20 is a perspective view of the eleventh embodiment of the electric connecting device.

FIG. 21 is a perspective view showing the state of use of the eleventh embodiment of the electric connecting device.

FIG. 22 is a perspective view of the twelfth embodiment of the electric connecting device.

FIG. 23 is a sectional view of the twelfth embodiment of the electric connecting device.

FIG. 24 is a perspective view of the thirteenth embodiment of the electric connecting device.

FIG. 25 is a sectional view of the thirteenth embodiment of the electric connecting device.

FIG. 26 is a perspective view of the fourteenth embodiment of the electric connecting device.

FIG. 27 is a perspective view of the fifteenth embodiment of the electric connecting device.

FIG. 28 is a perspective view of the sixteenth embodiment of the electric connecting device.

FIG. 29 is a perspective view of an electric connector using the thirteenth embodiment of the electric connecting device.

FIG. 30 is a sectional view of the electric connector using the thirteenth embodiment of the electric connecting device.

FIG. 31 is a schematic diagram showing another embodiment of the method of connecting an electric wire to the electric connector.

FIG. 32 is a schematic structural diagram of the lead-free ultrahigh-conductive plastic used in the embodiments.

FIG. 33 is a schematic structural diagram of the conventional plastic wherein powder of a metal that does not melt is kneaded in a resin.

### DESCRIPTION OF PREFERRED EMBODIMENTS OF THE INVENTION

In the following, some embodiments of the electric connecting device using resin solder and the method of connecting an electric wire to the electric connecting device according to the present invention will be described.

First, the above-mentioned lead-free ultrahigh-conductive plastic, which is commonly used in all the embodiments of the electric connecting device, will be described in detail according to the description of Japanese Patent unexamined publication gazette Heisei 10-237331. This lead-free ultrahigh-conductive plastic is a conductive resin composite, which comprises a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal. This lead-free ultrahigh-conductive plastic includes those wherein lead-free solder parts that are finely dispersed in the above-mentioned thermoplastic resin are continuously connected to each other in the entire resin. The above-mentioned lead-free ultrahigh-conductive plastic includes those of which above-mentioned conductive resin composite has such a conductivity that the volume resistivity thereof is as low as 10⁻³ Ω·cm or under.

The synthetic resin to be used for this lead-free ultrahigh-conductive plastic is not specifically limited, and those that have been used conventionally can be used. However, from the viewpoints of ease in molding and some other physical properties required, it is preferable to use a thermoplastic resin.

The metal to be used for this lead-free ultrahigh-conductive plastic must be a lead-free metal that can half melt when the synthetic resin composite containing the metal is heat-plasticated. As the heat plastication temperature of thermoplastic resin is normally 350° C. or under, low-melting-point metals having a melting point below the above-mentioned plastication temperature are preferable. The metal may be a pure metal or an alloy. As the metal is kneaded under half-melted condition, its configuration is not limited particularly. However, a granular form or a powdery form of metal is preferable since it is easy to handle for dispersion.

Specific examples of the above-mentioned metal include zinc (Zn), tin (Sn), bismuth (Bi), aluminum (Al), cadmium (Cd), indium (In) and their alloys. Examples of preferred alloys among them include low-melting-point alloys such as Sn—Cu, Sn—Zn, Sn—Al and Sn—Ag.

Metals in powdery form for assisting dispersion of the solder include copper (Cu), nickel (Ni), aluminum (Al), chromium (Cr) and their alloys all in powdery form. The finer is the particle diameter of the metal powder, the finer is the dispersion of the solder after kneading. However, it is not necessary to provide powder of a common particle diameter. Powder of a metal having a distribution of particle diameters can be used. The usage of the metal components in the above-mentioned lead-free ultrahigh-conductive plastic is from 30 to 75% and preferably from 45 to 65% in volume ratio to the entire conductive resin composite.

The above-mentioned lead-free ultrahigh-conductive plastic uses a resin and a low-melting-point alloy (lead-free solder) which does not contain lead from the viewpoint of environment. As they are kneaded when the metal is kept in a half-melted state, the lead-free solder being metal components can be dispersed finely throughout the resin. Moreover, as kneading is made when the lead-free solder is kept under a half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence electric connecting devices and the like can be formed by processes of injection molding alone. Moreover, as no plating is required, a conductive part of low resistance can be formed inside the injection molding.

To produce the above-mentioned conductive resin composite, kneading machines and extruding machines for conventional resins can be used.

Next, embodiments of the above-mentioned lead-free ultrahigh-conductive plastic will be described.

### Embodiment 1

45% by volume of ABS resin (produced by Toray; Toyolac 441), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into a kneader (Moriyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by a plunger extrusion pelletizer (Toshin make, Model TP60-2) at the dies temperature ranging from 200 to 240° C. to produce pellets. These pellets were used to make injection molding into molds by an injection molding machine (Kawaguchi Tekko make, KS10B). The preset temperature was from 230 to 280° C., and the mold temperature was from the ordinary temperature to 150° C. The injection moldings obtained showed no sign of segregation of metal, and their surfaces were even.

Observation, under an optical microscope, of the state of dispersion of the solder of this injection molding showed that the solder was evenly dispersed throughout the resin and solder fractions were about 5 μm in size. The volume resistivity of this specimen was on the order of 10⁻⁵ Ω·cm.

### Embodiment 2

45% by volume of PBT resin (produced by Polyplastic), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into the kneader (Moriyama Seisakusho make, double-screw pressurized type) which was set at 220° C. The mixture was kneaded, without preheating time, at a rate ranging from 25 to 50 r.p.m. for 20 minutes while efforts were made to prevent the temperature of the kneaded material from rising to 235° C. or over, by lowering the rate of revolution, cooling, etc.; the resin was heat-plasticated and the solder, under half-melted condition, was dispersed throughout the resin.

Observation, under an optical microscope, of the state of dispersion of the solder of the kneaded material showed that the solder was evenly dispersed throughout the resin and solder fractions were about 5 μm in size.

### Embodiment 3

35% by volume of ABS resin (produced by Toray; Toyolac 441), 55% by volume of lead-free solder (produced by Fukuda Kinzoku Hakufun Kogyo; Sn—Cu—Ni—AtW-150) and 10% by volume of copper powder (produced by Fukuda Kinzoku Hakufun Kogyo; FCC-SP-77, mean particle diameter 10 μm) were lightly mixed together, and the total of the metal components was set at 65% by volume. Then the mixture was fed into the kneader (Moriyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by the plunger extrusion pelletizer (Toshin make, Model TP60-2) at the dies temperature ranging from 200 to 240° C. to produce pellets. These pellets were used to make injection molding into molds by the injection molding machine (Kawaguchi Tekko make, KS-10B). The preset temperature of the machine was from 230 to 280° C., and the mold temperature was from the ordinary temperature to 150° C. The injection moldings obtained showed no sign of segregation of metal, and their surfaces were even. Observation, under an optical microscope, of the state of dispersion of the solder showed that the solder was evenly dispersed throughout the resin and solder fractions were about 100 μm or under in size. The volume resistivity of this specimen was on the order of 4×10⁻³ Ω·cm.

As clearly shown by the above-mentioned specific examples, the lead-free solder could be dispersed finely throughout the resins, and even when a large volume of metal components as high as 65% by volume were mixed, a kneaded material that did not show any segregation, under heating, of metals from the resin was obtained successfully. As the solder fractions were continuous to each other in this lead-free ultrahigh-conductive plastic, the conductivity of the plastic did not show any deterioration even when the temperature changed, thus the plastic stably exhibited high conductivity. In injection molding, the plastic was successfully molded into fine configurations without any clogging.

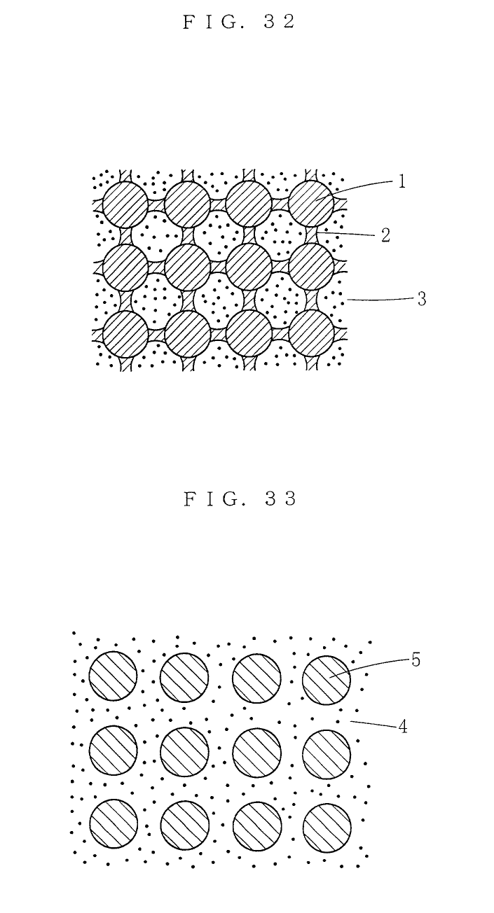

With the use of this lead-free ultrahigh-conductive plastic, electric connecting devices and the like having a three-dimensional configuration and low resistance can be formed by injection molding. In the following, with reference to the attached drawings, specific examples will be described in detail. FIG. 32 is a schematic structural diagram of the above-mentioned lead-free ultrahigh-conductive plastic. As shown in this diagram, in this lead-free ultrahigh-conductive plastic, the lead-free solders 1 are connected to each other by the solders 2 which are melted in the plastic 3. Hence the lead-free solders 1 are junctioned to each other and the conductivity is high and the reliability of the connection is high.

In contrast to this, as shown in FIG. 33, when powder 5 of a conventional metal that does not melt is kneaded in a plastic 4, the metal particles will not connect to each other unless a large amount of the metal content is mixed. Hence conductivity can not be obtained.

Thus the lead-free ultrahigh-conductive plastic shows a low resistance, does not exhibit deterioration in conductivity in a variety of environments, and has a high reliability.

To sum up, when a resin and a low-melting-point alloy (lead-free solder) which does not contain lead from the viewpoint of environment are used, and they are kneaded with the metal being kept in half-melted condition, the lead-free solder being the metal components can be dispersed finely throughout the resin. Moreover, as kneading is made when the lead-free solder is kept in half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence electric connecting devices and the like can be formed by processes of injection molding alone. Moreover, as no plating is required, a conductive part of low resistance can be formed inside the frame (injection molding).

Next, embodiments of the electric connecting device using the resin solder will be described. This electric connecting device is, for example, a terminal, a contact or a piercing contact element. It is a member to which an electric wire is connected and which exhibits a function of coupling with a counterpart member or fitting with a counterpart member. This electric connecting device has conductivity. This electric connecting device is provided with a first connecting part which couples with a counterpart member or fits with a counterpart member, and a second connecting part to which the conductor of an electric wire is connected. When the electric connecting device is a terminal, the first connecting part is, for example, a tongue. When the electric connecting device is a male contact such as a pin, a post or a tub, the first connecting part is a protruding part of the male contact. When the electric connecting device is a female contact such as a socket or a receptacle, the first connecting part is a tubular part, which receives the protruding part of the male contact to make electric connection on the internal surface thereof. When the electric connecting device is a piercing contact element, the first connecting part is a part that contacts the connector pin. Of the electric connecting device, at least a part of the second connecting part to which the conductor of an electric wire is connected is made of the lead-free ultrahigh-conductive plastic being the conductive resin composite. In this case, of the electric connecting device, the part of the second connecting part to which the conductor of the electric wire is connected is made of the lead-free ultrahigh-conductive plastic, and other parts may be made of another material having conductivity, or the entirety of the electric connecting device may be made of the lead-free ultrahigh-conductive plastic.

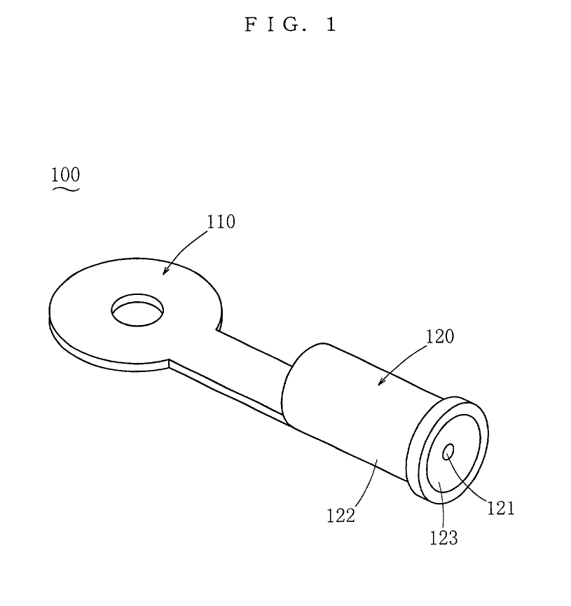

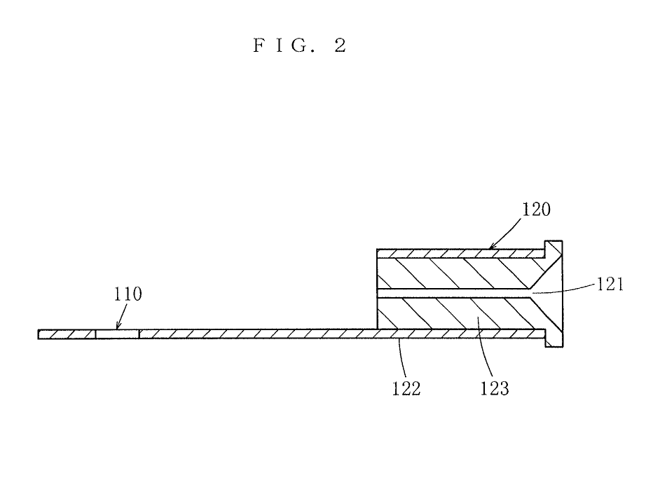

The electric connecting device 100 of the first embodiment is a terminal shown in FIG. 1 and FIG. 2. An electric wire 200 is connected to this electric connecting device 100, and the device 100 is coupled with a counterpart member of, for example, a printed circuit board. The first connecting part 110, which is provided at one end of the electric connecting device 100, is a tongue, and this tongue is fixed by a screw on, for example, a printed circuit board. Here the tongue has an O-shape having a screw hole at the center, but embodiments wherein the tongue has a U-shape are included. The second connecting part 120, which is provided at the other end of the electric connecting device 100, is provided with a hole 121 into which the conductor 210 of the electric wire 200 is inserted. In this electric connecting device 100, the inner wall of the above-mentioned hole 121 is made of the lead-free ultrahigh-conductive plastic, and other parts are made of another material having conductivity. The hole 121 may penetrate through the second connecting part 120. The hole 121 may be a non-through hole. Either will do.

The second connecting part 120 is provided with a tubular member 122, which is integrally provided to the first connecting part 110, and a connecting member 123, which fits into the tubular member 122 and has a bole 121 into which the conductor 210 of the electric wire 200 is inserted. This connecting member 123 is made of the lead-free ultrahigh-conductive plastic, and the tubular member 122 is made of another material having conductivity.

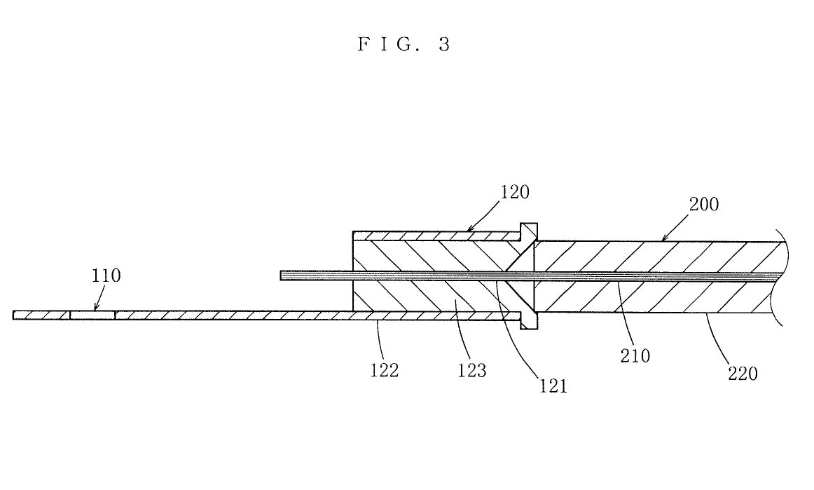

Accordingly, as shown in FIG. 3, when the conductor 210 of the electric wire 200 is placed on the part of the second connecting part 120 of the electric connecting device 100, to which the conductor 210 of the electric wire 200 is to be connected, and their contacting parts are heated, the lead-free solder which is contained in the lead-free ultrahigh-conductive plastic of this part will melt out to stick to the conductor 210 of the electric wire 200. When this lead-free solder cools and solidifies, the conductor 210 of the electric wire 200 will be connected to the electric connecting device 100. Then the electric connecting device 100 will be coupled with a counterpart member or fitted with a counterpart member by the first connecting part 110. The above-mentioned heating is effected by, for example, blowing hot air or irradiating high frequency waves or laser beams to give thermal energy. Hence the work of separately applying solder is not required. Thus the electric wire 200 can be easily connected to a part where soldering is difficult or impossible such as a recess of the electric connecting device 100. Moreover, as quality control, temperature control and the like of the solder are not required, the control man-hour will be reduced correspondingly. Furthermore, connection of a very fine wire can be made by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric connecting device 100 can be reduced. After connection of the electric wire 200, when electricity is passed at a normal level, the lead-free ultrahigh-conductive plastic will not melt due to heat generation. In comparison with the technology of MID wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding. Hence, of the electric connecting device 100, each part to be made of the lead-free ultrahigh-conductive plastic can be molded to a variety of configurations according to the application. This makes it easier to obtain impedance matching.

In the first embodiment, the connecting member 123 is made of the lead-free ultrahigh-conductive plastic, and other parts are made of another material having conductivity. If the other parts are made of a material that has a higher strength and a higher elasticity than those of the lead-free ultrahigh-conductive plastic, such as a metal, for example, a copper alloy, the strength and the elasticity of the electric connecting device 100, in particular, those of the first connecting part 110 will be enhanced. In that case, the electric connecting device 100 can be produced by insert molding being a kind of injection molding.

In the present invention, the configuration of the second connecting part is not limited. Among its embodiments, in the electric connecting device of the first embodiment, the second connecting part 120 is provided with the hole 121 into which the conductor 210 of an electric wire 200 is inserted, and at least the inner wall of the above-mentioned hole 121 is made of the lead-free ultrahigh-conductive plastic. With this arrangement, when the conductor 210 of the electric wire 200 is inserted into the hole 121 of the second connecting part 120, the electric wire 200 will be tacked onto the electric connecting device 100. When the hole 121 is heated and then cooled, the conductor 210 of the electric wire 200 will be connected to the electric connecting device 100. As the electric wire 200 can be tacked onto the electric connecting device 100, the work of connecting the electric wire 200 to the electric connecting device 100 can be done easily.

Moreover, in the first embodiment, the second connecting part 120 is provided with the tubular member 122 and the connecting member 123, which fits into the tubular member 122 and has the hole 121 into which the conductor 210 of an electric wire 200 is inserted, and the connecting member 123 is made of the lead-free ultrahigh-conductive plastic and the tubular member 122 is made of another material having conductivity. With this arrangement, the electric connecting device 100 can be produced by forming the connecting member 123 with the lead-free ultrahigh-conductive plastic and fitting the connecting member 123 into the tubular member 122. Thus the production of the electric connecting device 100 is easy.

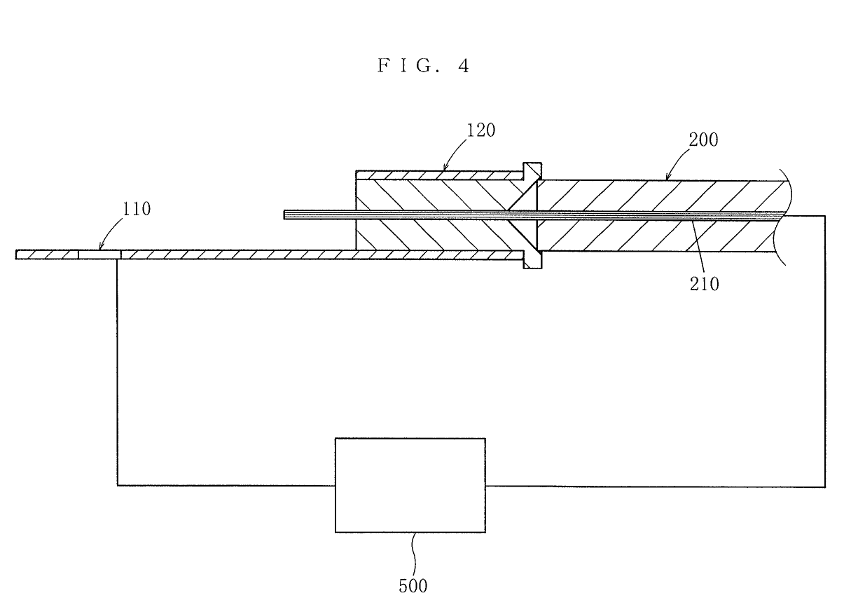

Another embodiment of the method of connecting the electric wire 200 to the electric connecting device 100 will be described. As shown in FIG. 4, first the conductor 210 of the electric wire 200 is inserted into the second connecting part 120 of the electric connecting device 100. Next, electricity is passed between the electric connecting device 100 and the conductor 210 of the electric wire 200 by a power source 500 to fuse the lead-free solder which is contained at least in the part of the second connecting part 120 to which the conductor 210 of the electric wire 200 is to be connected. As a result, the conductor 210 of the electric wire 200 will be connected to the electric connecting device 100.

When this method is used, as the second connecting part 120 generates heat by itself, even if it is difficult to externally heat the contacting parts of both the second connecting part 120 and the conductor 210 of the electric wire 200, the electric wire 200 can be connected to the electric connecting device 100.

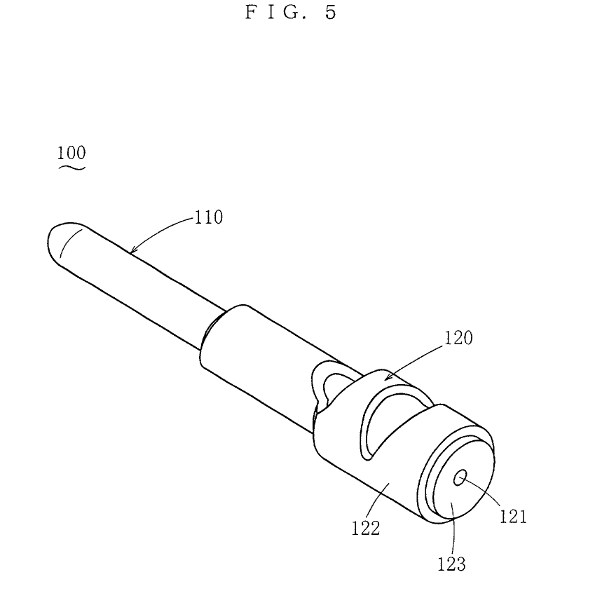

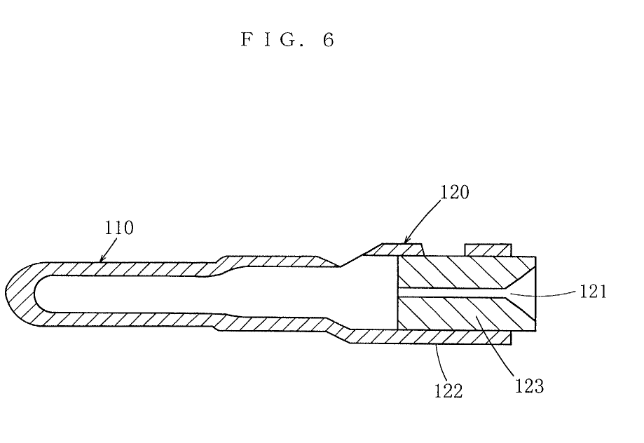

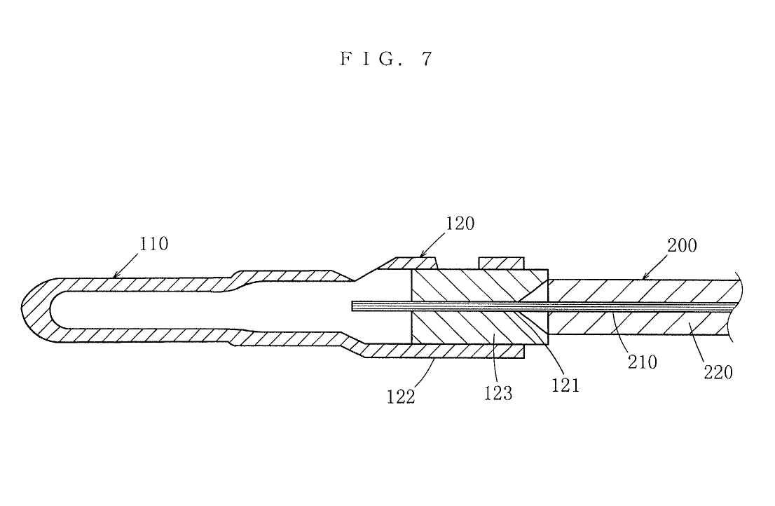

In the following, other embodiments will be described. When there is an embodiment which is closest to an embodiment to be described, the description of the former will be quoted together with the marks. Then additional description will be made regarding differences in structure from the closest embodiment. FIG. 5 through FIG. 7 show a male contact being the electric connecting device 100 of the second embodiment. The closest embodiment is the first embodiment. An electric wire 200 is connected to this electric connecting device 100, and the device 100 is fitted with a female contact being a counterpart member. The first connecting part 110, which is provided at one end of the electric connecting device 100, is a pin, and this pin is inserted into or extracted from a tubular part of the female contact. The second connecting part 120, which is provided on the other end of the electric connecting device 100, is provided with a hole 121 into which the conductor 210 of the electric wire 200 is inserted. The inner wall of the above-mentioned hole 121 of the electric connecting device 100 is made of the lead-free ultrahigh-conductive plastic, and the other parts are made of another material having conductivity. The hole 121 may penetrate through the second connecting part 120. The hole 121 may be a non-through hole. Either will do.

The second connecting part 120 is provided with a tubular member 122, which is integrally provided on the first connecting part 110, and a connecting member 123, which fits into the tubular member 122 and has the hole 121 into which the conductor 210 of the electric wire 200 is inserted. The connecting member 123 is made of the lead-free ultrahigh-conductive plastic, and the tubular member 122 is made of another material having conductivity.

The functions and effects obtained by the second embodiment are similar to the functions and effects described on the first embodiment.

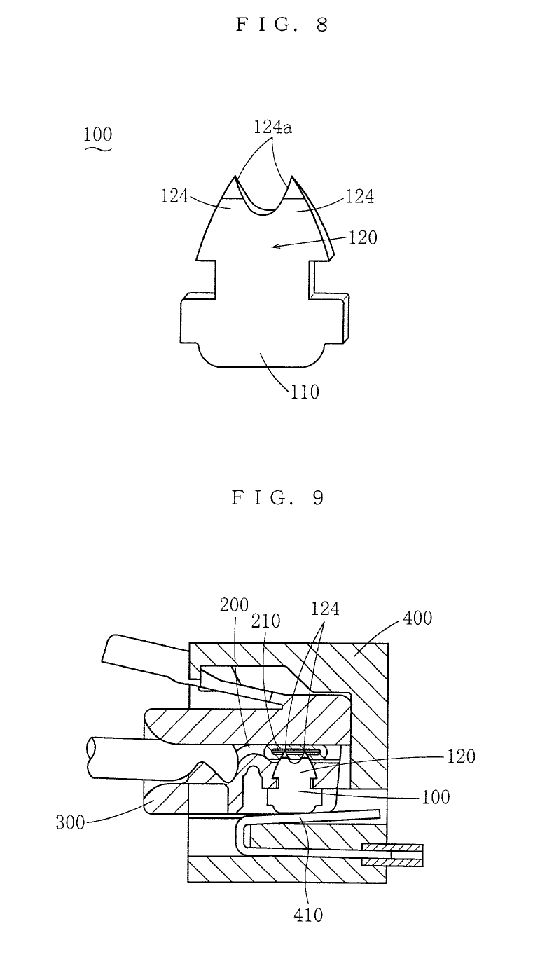

FIG. 8 shows a piercing contact element being the electric connecting device 100 of the third embodiment. An electric wire 200 is connected to this electric connecting device 100, then the device 100 is made to contact a connector pin being the counterpart member. The electric connecting device 100 is formed into an almost flat plate. One end is formed into the first connecting part 110, which contacts the connector pin 410. The other end is formed into the second connecting part 120. The second connecting part 120 has angular piercing parts 124. As shown in FIG. 9, when the electric wire 200 is inserted into the first connector 300, and then the electric connecting device 100 is pushed into the first connector 300, the second connecting part 120 of the electric connecting device 100 will pierce into the electric wire 200 (a signal line of a coaxial cable in this case) till the conductor 210 is reached. Next, when the first connector 300 is inserted into the second connector 400, the connector pin 410, which comprises a conductive leaf spring being cantilevered on the second connector 400, will contact the first connecting part 110 of the electric connecting device 100 and the electric wire 200 and the connector pin 410 will be electrically connected to each other. Of the electric connecting device 100, the top ends 124a of the above-mentioned piercing parts 124 are made of the lead-free ultrahigh-conductive plastic, and other parts are made of another material having conductivity.

In the case of the electric connecting device 100 of the third embodiment, as shown in FIG. 9, when the piercing parts 124 are made to pierce into the electric wire 200, the electric wire 200 will be fitted onto the electric connecting device 100. When the piercing parts 124 are heated, the lead-free solder being contained in the lead-free ultrahigh-conductive plastic of the piercing parts 124 will melt out and adhere to the conductor 210 of the electric wire 200. When the lead-free solder cools and solidifies, the conductor 210 of the electric wire 200 will be connected to the electric connecting device 100, and the connection strength between them will be enhanced. The above-mentioned heating is effected by, for example, blowing hot air or irradiating high frequency waves or laser beams to give thermal energy. Accordingly, the work of separately applying solder is not required. Hence the electric wire 200 can be easily connected to a part that is difficult or impossible to be soldered, such as a recess of the electric connecting device 100. Moreover, as quality control, temperature control and the like of the solder are not required, the control man-hour will be reduced correspondingly. Furthermore, connection of a very fine wire can be made by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric connecting device 100 can be reduced. After connection of the electric wire 200, when electricity is passed at a normal level, the lead-free ultrahigh-conductive plastic will not melt due to heat generation. In comparison with the technology of MID wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding. Hence, of the electric connecting device 100, each part to be made of the lead-free ultrahigh-conductive plastic can be molded to a variety of configurations according to the application. This makes it easier to obtain impedance matching.

In the third embodiment, the top ends 124a of the piercing parts 124 are made of the lead-free ultrahigh-conductive plastic, and other parts are made of another material, but if the other parts are made of a material that has a higher strength and a higher elasticity than those of the lead-free ultrahigh-conductive plastic, such as a metal, for example, a copper alloy, the strength and the elasticity of the electric connecting device 100, in particular, those of the first connecting part 110 will be enhanced.

The present invention does not limit the configuration of the second connecting part. Among embodiments of the present invention, in the electric connecting device of the third embodiment, the second connecting part 120 is provided with piercing parts 124, which are made to pierce till the conductor 210 of the electric wire 200 is reached, and the top ends 124a of the above-mentioned piercing parts 124 are made of the lead-free ultrahigh-conductive plastic. With this arrangement, when the piercing parts 124 are made to pierce the electric wire 200, the electric wire 200 will be fitted to the electric connecting device 100. When the piercing parts 124 are heated, then they are cooled, the conductor 210 of the electric wire 200 will be connected to the electric connecting device 100, and the connection strength between them will be increased.

The other embodiment of the method of connecting the electric wire 200, which was described above in relation to the first embodiment, can be applied to the third embodiment, and similar functions and effects can be obtained.

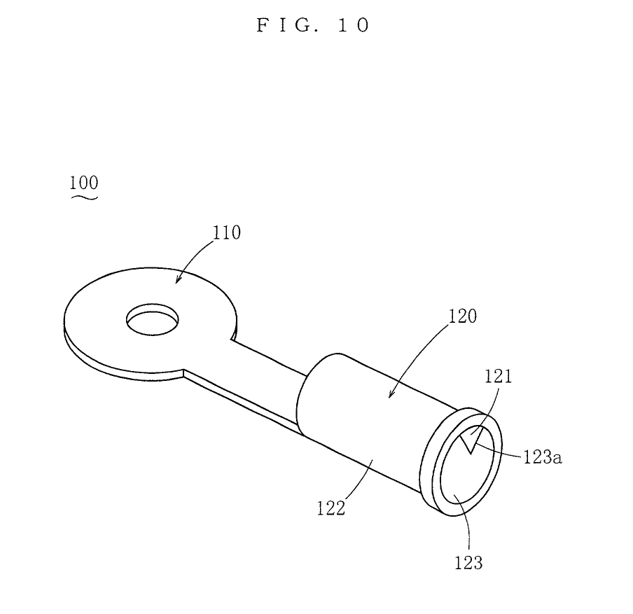

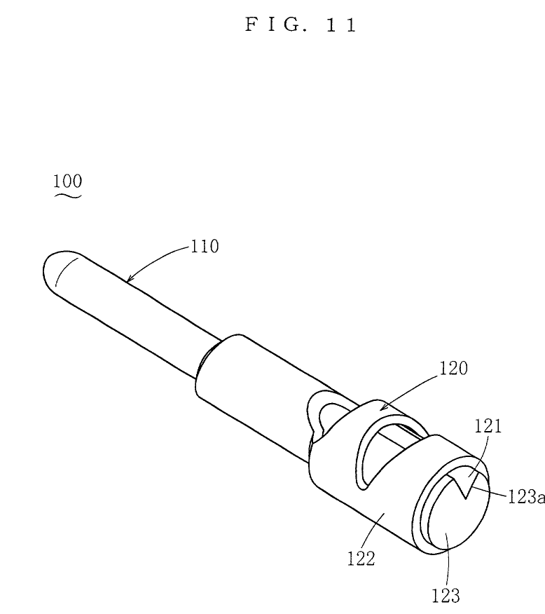

FIG. 10 shows a terminal being the electric connecting device 100 of the fourth embodiment. FIG. 11 shows a male contact being the electric connecting device 100 of the fifth embodiment. The closest embodiments are the first embodiment and the second embodiment, respectively. In these electric connecting devices 100, a part of the circumferential face of the connecting part 123 is notched to form a notch 123a. Thus a hole 121 is formed between the notch 123a and the tubular member 122. The notch 123a may be formed to extend from one end to the other end of the second connecting part 120 or to extend short of the other end.

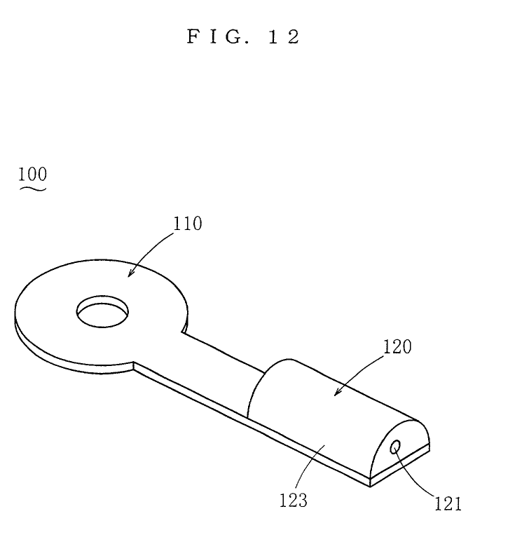

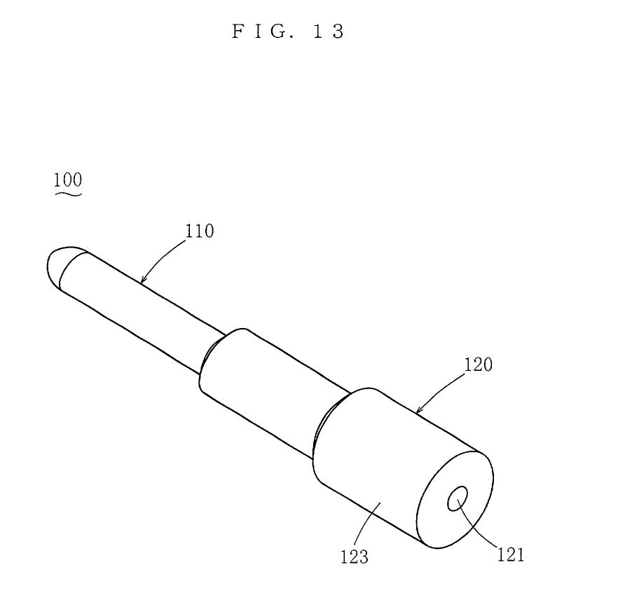

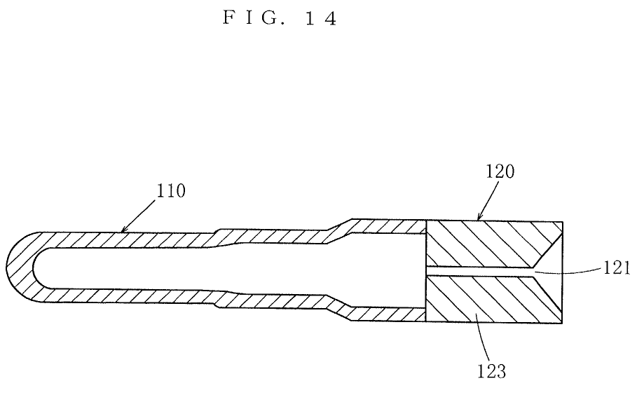

FIG. 12 shows a terminal being the electric connecting device 100 of the sixth embodiment, and FIG. 13 and FIG. 14 show a male contact being the electric connecting device 100 of the seventh embodiment. The closest embodiments are the first embodiment and the second embodiment, respectively. These electric connecting devices 100 are formed by coupling the connecting member 123, which is made of the lead-free ultrahigh-conductive plastic, with a member which is made of another material having conductivity through heat welding, adhesion, etc. In the electric connecting device 100 of the sixth embodiment, the first connecting part 110 being made of the other material having conductivity is just extended to form a substrate of the second connecting part 120, and the connecting member 123, which has a hole 121 into which the conductor 210 of the electric wire 200 is inserted and is made of the lead-free ultrahigh-conductive plastic, is placed upon and coupled with the substrate. The substrate and the connecting member 123 constitute the second connecting part 120. In the electric connecting device 100 of the seventh embodiment, the connecting member 123, which has a hole 121 into which the conductor 210 of the electric wire 200 is inserted and is made of the lead-free ultrahigh-conductive plastic, is coupled to the first connecting part 110, which is made of another material having conductivity, and the connecting member 123 constitutes the second connecting part 120.

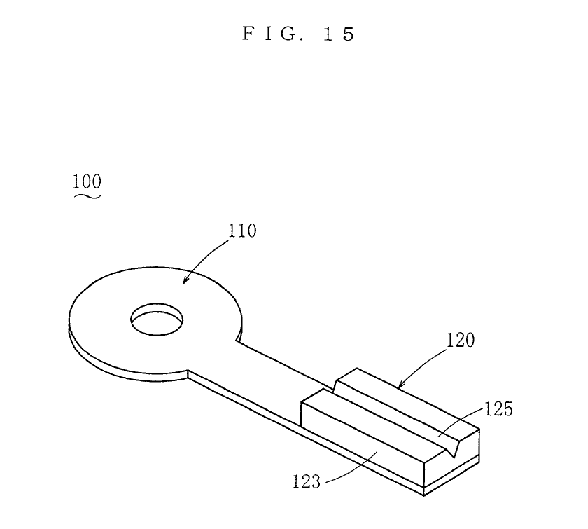

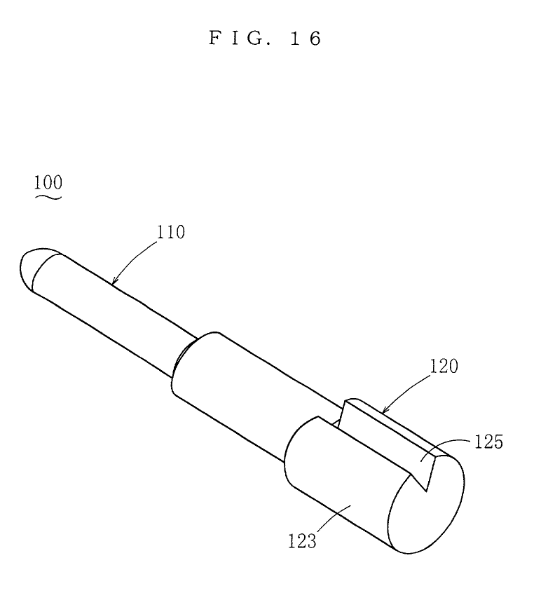

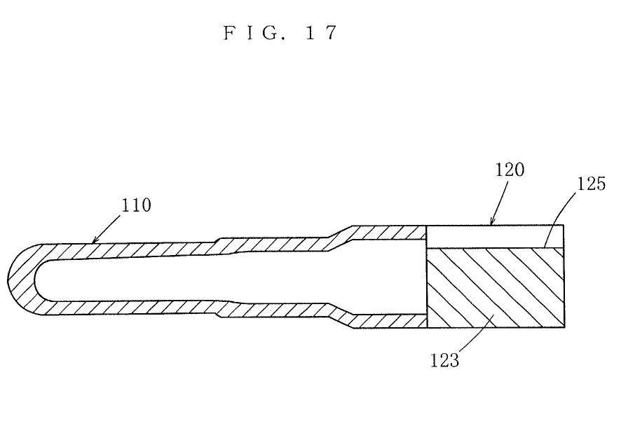

FIG. 15 shows a terminal being the electric connecting device 100 of the eighth embodiment, and FIG. 16 and FIG. 17 show a male contact being the electric connecting device 100 of the ninth embodiment. The closest embodiments are the sixth embodiment and the seventh embodiment, respectively. In the electric connecting devices 100 of the sixth embodiment and the seventh embodiment, the second connecting part 120 has the hole 121. In the electric connecting devices 100 of the eighth embodiment and the ninth embodiment, the second connecting part 120 has a groove 125, in place of the hole 121, to receive the conductor 210 of the electric wire 200, and at least the surface layer of the above-mentioned groove 125 is made of the lead-free ultrahigh-conductive plastic and other parts are made of another material having conductivity. In these embodiments, the groove 125 is formed in the circumferential face of the connecting member 123 being similarly constructed to those of the electric connecting devices 100 of the sixth embodiment and the seventh embodiment. The groove 125 may be formed from one end to the other end of the second connecting part 120 or it may extend short of the other end.

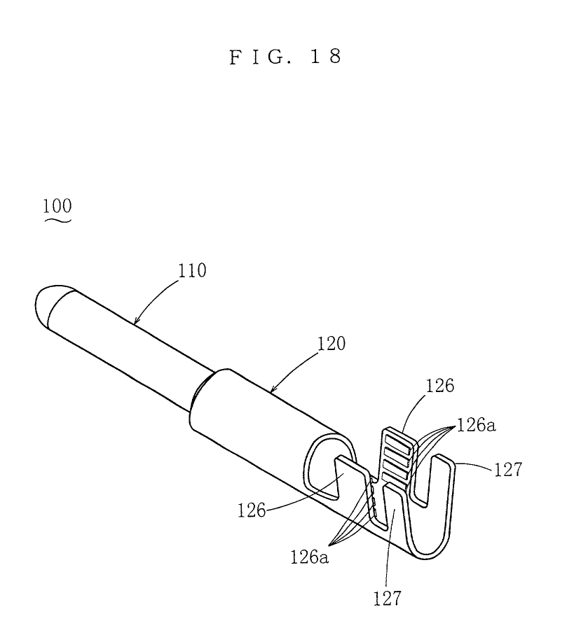

FIG. 18 shows a male contact of crimp type being the electric connecting device 100 of the tenth embodiment. The first connecting part 110 of the electric connecting device 100 is a protruding part. The second connecting part 120 of the electric connecting device 100 is provided with a U-shaped wire barrel 126, which crimps the conductor 210 of the electric wire 200, and a U-shaped insulation barrel 127, which crimps the insulation 220 of the electric wire 200. Apart of the wire barrel 126, which contacts the conductor 210, is made of the lead-free ultrahigh-conductive plastic, and the other part is made of another material having conductivity. In this embodiment, pads 126a being, for example, rectangular and made of the lead-free ultrahigh-conductive plastic are attached onto the inner face of the wire barrel 126 through heat welding, adhesion, etc. A plurality of pads 126a are arranged from the root end to the top end of the wire barrel 126 so that the pads 126a are prevented from being damaged when the wire barrel 126 is folded.

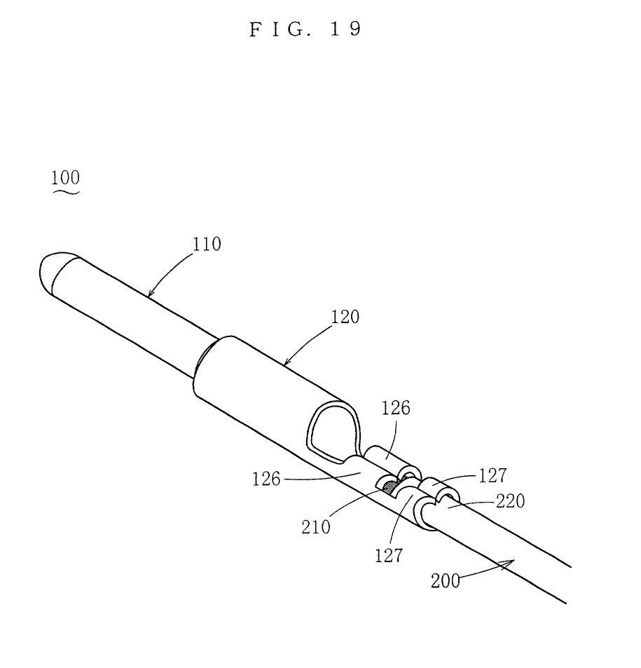

In the case of the tenth embodiment, as shown in FIG. 19, when the conductor 210 of the electric wire 200 is crimped by the wire barrel 126, the electric wire 200 will be fitted onto the electric connecting device 100. Then, when the wire barrel 126 is heated, the lead-free solder being contained in the lead-free ultrahigh-conductive plastic of the pads 126a will melt out and stick to the conductor 210 of the electric wire 200. When the lead-free solder cools and solidifies, the conductor 210 of the electric wire 200 will be connected to the electric connecting device 100 and the connection strength between them will be increased. The above-mentioned heating is effected by blowing hot air or irradiating high frequency waves or laser beams to give thermal energy. Thus, when the conductor 210 of the electric wire 200 is to be connected to the wire barrel 126, the work of separately applying solder is not required. Hence the electric wire 200 can be easily connected to a part that is difficult or impossible to be soldered after crimping such as the inner surface of the wire barrel 126. Moreover, as quality control, temperature control and the like of the solder are not required, the control man-hour will be reduced correspondingly. Furthermore, connection of a very fine wire can be made by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric connecting device 100 can be reduced. After connection of the electric wire 200, when electricity is passed at a normal level, the lead-free ultrahigh-conductive plastic will not melt due to heat generation. In comparison with the technology of MID wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding. Hence, of the electric connecting device 100, each part to be made of the lead-free ultrahigh-conductive plastic can be molded to a variety of configurations according to the application. This makes it easier to obtain impedance matching. In the above-mentioned embodiment, the lead-free ultrahigh-conductive plastic is attached to the wire barrel 126 in the form of pads 126a, but the surface layer of the inner face of the wire barrel 126 may be made of the lead-free ultrahigh-conductive plastic.

In the tenth embodiment, the part of the wire barrel 126 which contacts the conductor 210 is made of the lead-free ultrahigh-conductive plastic, and other parts are made of another material having conductivity. However, if the other parts are made of a material that has a higher strength and a higher elasticity than those of the lead-free ultrahigh-conductive plastic, such as a metal, for example a copper alloy or the like, the strength and the elasticity of the electric connecting device 100, in particular, those of the first connecting part 110 will be enhanced.

The other embodiment of the method of connecting the electric wire 200, which was described above in relation to the first embodiment, can be used in the tenth embodiment and similar functions and effects can be obtained.

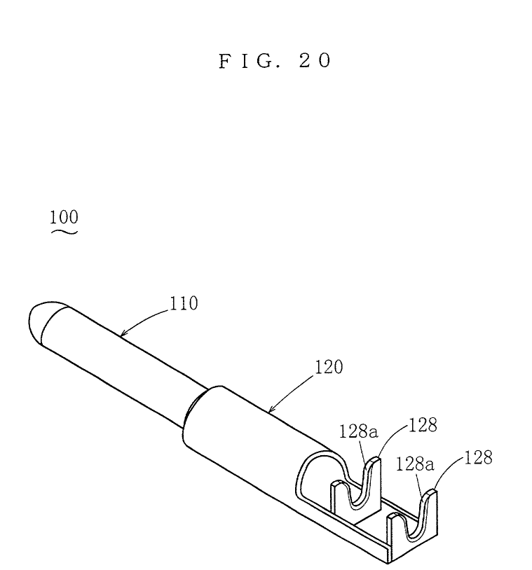

FIG. 20 shows a male contact of insulation displacement contact type being the electric connecting device 100 of the eleventh embodiment. The closest embodiment is the tenth embodiment. The first connecting part 110 of the electric connecting device 100 is a protruding part. The second connecting part 120 of the electric connecting device 100 is provided with slots 128 which displace the insulation 220 of the electric wire 200 and contact the conductor 210. The parts of the slots 120 which contact the conductor 210 are made of the lead-free ultrahigh-conductive plastic, and other parts are made of another material having conductivity. In this embodiment, at least the top ends 128a of the slots 128 are made of the lead-free ultrahigh-conductive plastic.

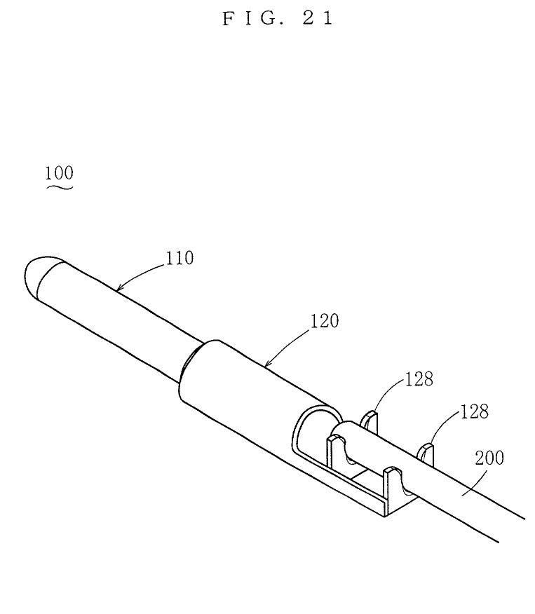

In the case of the eleventh embodiment, as shown in FIG. 21, when the conductor 210 of the electric wire 200 is pushed into the slots 128, the electric wire 200 will be fitted onto the electric connecting device 100. Then, when the slots 128 are heated, the lead-free solder being contained in the lead-free ultrahigh-conductive plastic of the slots 128 will melt out to adhere to the conductor 210 of the electric wire 200. When the lead-free solder cools and solidifies, the conductor 210 of the electric wire 200 will be connected to the electric connecting device 100 and the connection strength between them will be increased. The above-mentioned heating is effected by, for example, blowing hot air or irradiating high frequency waves or laser beams to give thermal energy. Hence, when the conductor 210 of the electric wire 200 is to be connected to the slots 128, the work of separately applying solder is not required. Thus the electric wire 200 can be easily connected to a part where soldering is difficult or impossible after insulation displacement contact of the electric wire 200 such as the slots 128. Moreover, as quality control, temperature control and the like of the solder are not required, the control man-hour will be reduced correspondingly. Furthermore, connection of a very fine wire can be made by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric connecting device 100 can be reduced. After connection of the electric wire 200, when electricity is passed at a normal level, the lead-free ultrahigh-conductive plastic will not melt due to heat generation. In comparison with the technology of MID wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding. Hence, of the electric connecting device 100, each part to be made of the lead-free ultrahigh-conductive plastic can be molded to a variety of configurations according to the application. This makes it easier to obtain impedance matching.

In the eleventh embodiment, the parts of the slots 128 which contact the conductor 210 are made of the lead-free ultrahigh-conductive plastic, and other parts are made of another material having conductivity. If the other parts are made of a material that has a higher strength and a higher elasticity than those of the lead-free ultrahigh-conductive plastic, such as a metal, for example, a copper alloy, the strength and the elasticity of the electric connecting device 100, in particular, those of the first connecting part 110 will be enhanced.

The other embodiment of the method of connecting the electric wire 200, which was described above in relation to the first embodiment, can be used in the eleventh embodiment and similar functions and effects can be obtained.

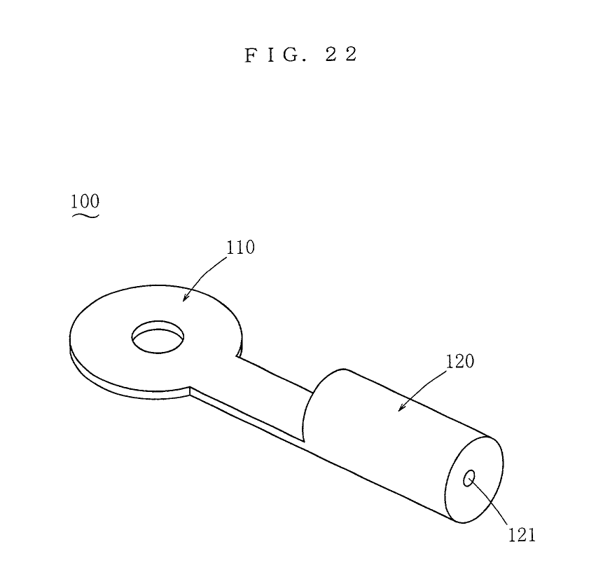

FIG. 22 through FIG. 28 show the electric connecting devices 100 of the twelfth embodiment through the sixteenth embodiment. In these embodiments, the first connecting part 110 is one end of a tongue, a protruding part or a plate, and the second connecting part 120 has a face onto which the conductor 210 of the electric wire 200 contacts, a hole 121 into which the conductor 210 of the electric wire 200 is inserted, a groove 125 which receives the conductor 210 of the electric wire 200 or piercing parts 124 which pierce into the electric wire 200 till the conductor 210 is reached, and the entirety is made of the lead-free ultrahigh-conductive plastic. The protruding part includes protruding parts of male contacts such as pin, post and tab.

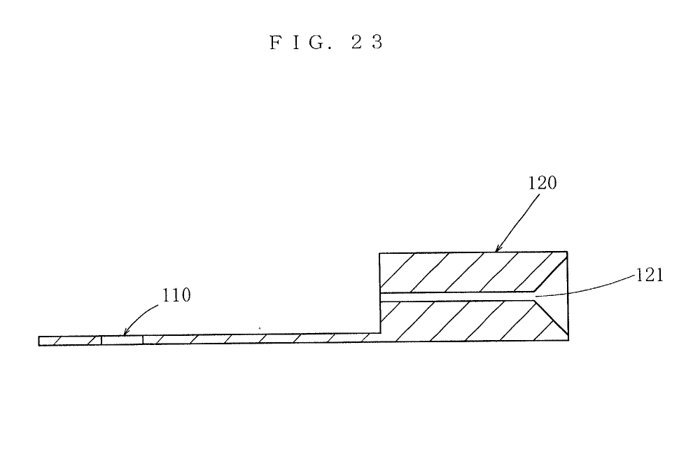

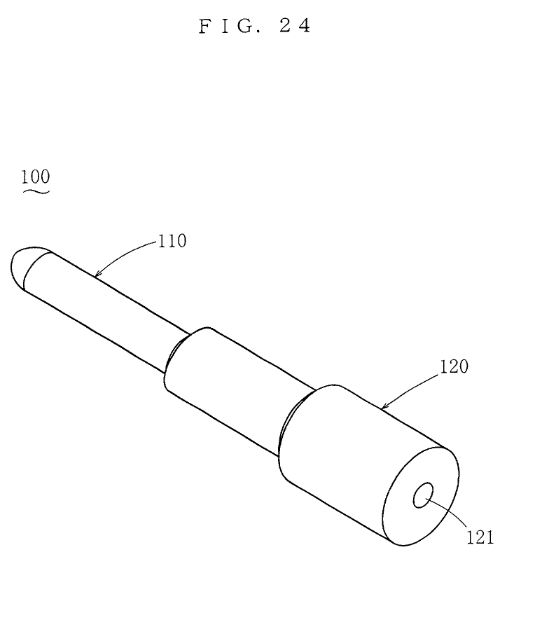

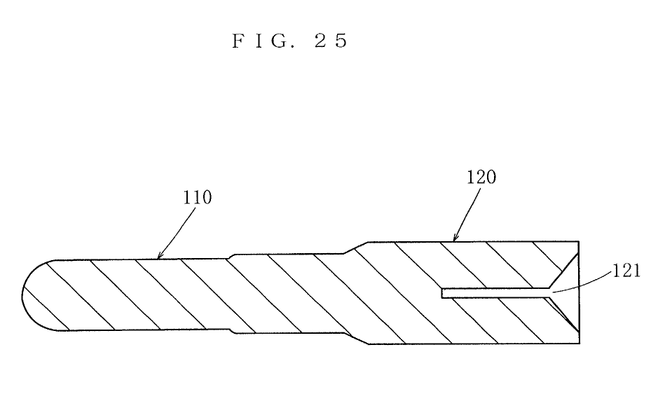

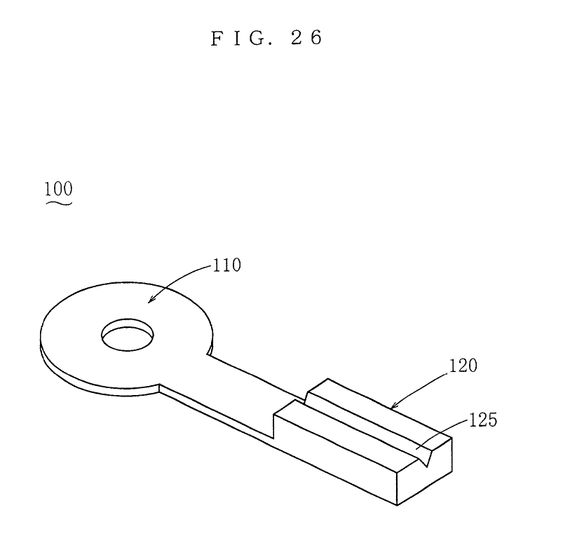

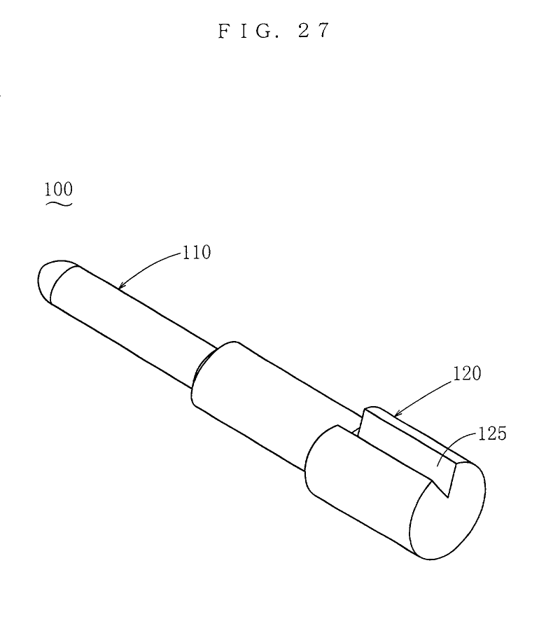

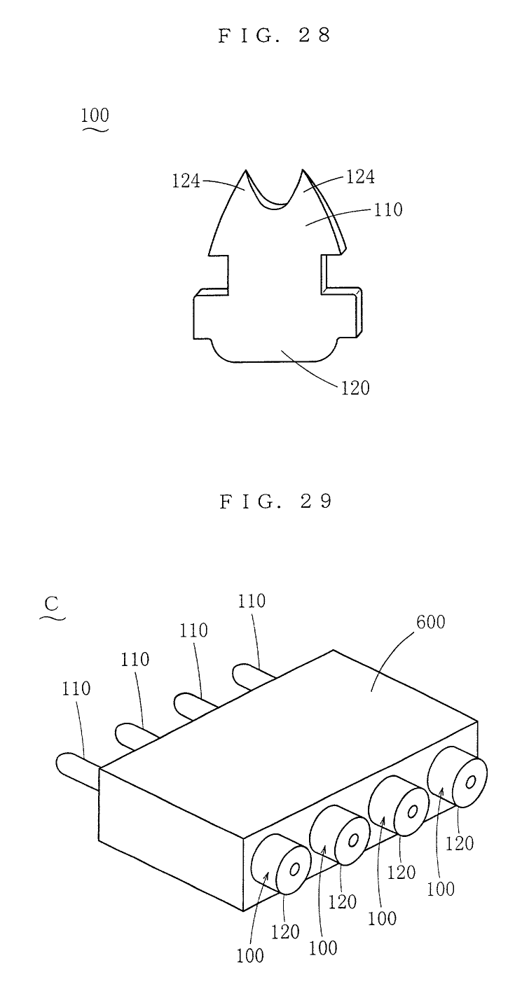

FIG. 22 and FIG. 23 show a terminal being the electric connecting device 100 of the twelfth embodiment, and FIG. 24 and FIG. 25 show a male terminal being the electric connecting device 100 of the thirteenth embodiment. The closest embodiments are the sixth embodiment and the seventh embodiment, respectively. FIG. 26 shows a terminal being the electric connecting device 100 of the fourteenth embodiment, and FIG. 27 shows a male contact being the electric connecting device 100 of the fifteenth embodiment. The closest embodiments are the eighth embodiment and the ninth embodiment, respectively. FIG. 28 shows a piercing contact element being the electric connecting device 100 of the sixteenth embodiment. The closest embodiment is the third embodiment. The electric connecting devices 100 of the sixth embodiment, the seventh embodiment, the eighth embodiment, the ninth embodiment and the third embodiment are made of a combination of materials whereas the electric connecting devices 100 of the twelfth embodiment, the thirteenth embodiment, the fourteenth embodiment, the fifteenth embodiment and the sixteenth embodiment are entirely made of the lead-free ultrahigh-conductive plastic.

The electric connecting devices 100 of the twelfth embodiment through the sixteenth embodiment can provide functions and effects which are obtained by their closest embodiments. The conductor 210 of the electric wire 200 is made to contact the face of the second connecting part 120, the conductor 210 of the electric wire 200 is inserted into the hole 121 of the second connecting part 120 or the conductor 210 of the electric wire 200 is received in the groove 125 to tack the electric wire 200 on the electric connecting device 100. Then, when the face, the hole 121 or the groove 125 is heated and then cooled, the conductor 210 of the electric wire 200 will be connected to the electric connecting device 100. When the piercing parts 124 are made to pierce the electric wire 200, the electric wire 200 will be fitted onto the electric connecting device 100. When the piercing parts 124 are heated and then cooled, the conductor 210 of the electric wire 200 will be connected to the electric connecting device 100 and the connection strength between them will be increased. In this case, as the first connecting part 110 and the second connecting part 120 are free of any part which is subjected to a large bending force or the like, no measures will be needed to improve the elasticity by designing the configurations of the respective connecting parts 110, 120. Thus design of the configuration is simple.

The present invention includes embodiments wherein, in electric connecting devices 100 of the twelfth embodiment through the sixteenth embodiment, a plated layer is formed on the surface of the first connecting part 110 to increase the hardness. With this arrangement, in addition to the functions and effects obtained in the twelfth embodiment through the sixteenth embodiment, the surface hardness of the first connecting part 110 is increased, and even if it is subjected to frictional forces, for example, by repeated insertion and extraction, the wear will be restrained and the durability will be improved.

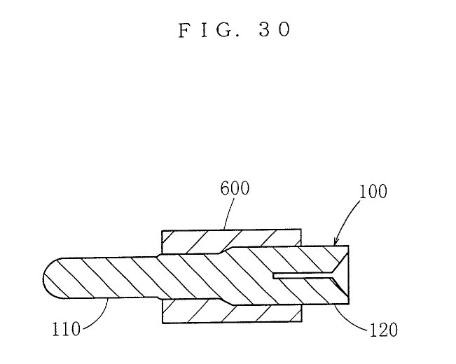

FIG. 29 and FIG. 30 show an electric connector using resin solder C being an embodiment of the electric connector using resin solder. The electric connector C is provided with the electric connecting devices 100 of the thirteenth embodiment and an insulating housing 600 which holds these electric connecting devices 100. The first connecting part 110 and the second connecting part 120 are exposed out of the insulating housing 600 so that the counterpart member and the electric wire 200 can be connected to them. The insulating housing 600 is made of a thermoplastic resin, and the electric connecting devices 100 and the insulating housing 600 are formed integrally.

In a way similar to that of the case of the electric connecting device 100 of the thirteenth embodiment, of the electric connecting device 100 of this electric connector C, the second connecting part 120 coming out of the insulating housing 600 is connected to the electric wire 200, and the first connecting part 110 is coupled with the counterpart member or fitted with the counterpart member. The functions and effects of that case are similar to the functions and effects of the electric connecting device 100 of the thirteenth embodiment.

In the present invention the material of the insulating housing is not limited to a thermoplastic resin. The present invention also includes embodiments wherein the electric connecting devices are assembled into the insulating housing by insertion or the like. Among such embodiments, in the electric connector C of the above-mentioned embodiment the insulating housing 600 is made of a thermoplastic resin and the electric connecting devices 100 and the insulating housing 600 are formed integrally. With this arrangement, as the electric connector C is produced by injection molding or the like, the efficiency of production is better in comparison with the case of separately producing the electric connecting devices 100 and the insulating housing 600 and assembling them together. Thus the method is suitable for mass production.

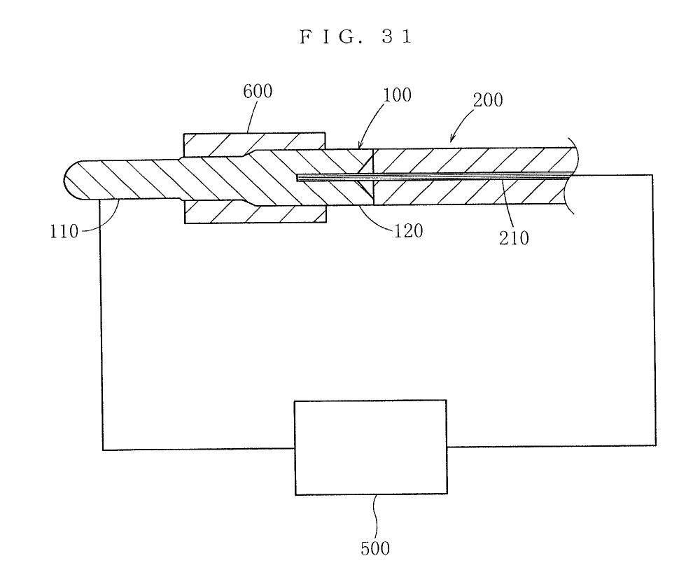

Another embodiment of the method of connecting the electric wire 200 to this electric connector C will be described. As shown in FIG. 31, the conductor 210 of the electric wire 200 is placed in the second connecting part 120 of the electric connecting device 100. Next, electricity is passed between the electric connecting device 100 and the conductor 210 of the electric wire 200 by a power source to melt the lead-free solder being contained in the electric connecting device 100 and connect the electric connecting device 100 to the conductor 210.

When this connecting method is used, as the electric connecting device 100 generates heat by itself, even if it is difficult to externally heat the contacting parts of the second connecting part 120 of the electric connecting device 100 and the conductor 210 of the electric wire 200 due to, for example, the interference by the insulating housing 600, the electric wire 200 can be connected to the electric connecting device 100.

The present invention includes all embodiments wherein features of the embodiments described above are combined. Among them, for example, the embodiments of the female contact wherein the first connecting part of the second embodiment, the fifth embodiment, the seventh embodiment, the ninth embodiment, the tenth embodiment and the eleventh embodiment is a tubular part are included. Moreover, embodiments of the electric connector comprising the electric connecting devices of the respective embodiments and an insulating housing for holding them are included.

With the description of these embodiments, the first electric connecting device using resin solder, which was described in the summary of the invention, has been fully disclosed. Moreover, with the description of these embodiments, the second through sixth electric connecting devices using resin solder, the methods of connecting electric wire to these electric connecting devices, the first and second electric connectors, and the methods of connecting electric wire to these electric connectors, which will be described below, have been fully explained.

The second electric connecting device using resin solder is the abovementioned first electric connecting device using resin solder, wherein the second connecting part is provided with a hole into which the conductor of the electric wire is inserted, a groove which receives the conductor of the electric wire or a piercing part which pierces the electric wire till the conductor thereof is reached, and at least an inner wall of the hole, a surface layer of the groove or a top end of the piercing part is made of the lead-free ultrahigh-conductive plastic.

With this arrangement, when the conductor of the electric wire is inserted into the hole of the second connecting part or is received by the groove thereof, the electric wire will be tacked to the electric connecting device. Then, when the hole or the groove is heated and then cooled, the conductor of the electric wire will be connected to the electric connecting device. Hence the work of connecting the electric wire to the electric connecting device can be done easily. When the piercing part is made to pierce the electric wire, the electric wire will be fitted onto the electric connecting device. Then when the piercing part is heated and then cooled, the conductor of the electric wire will be connected to the electric connecting device, and the connecting strength between them will be increased.

The third electric connecting device using resin solder is the second electric connecting device using resin solder, wherein the second connecting part is provided with a tubular member, and a connecting member which fits into the tubular member and has a hole into which the conductor of the electric wire is inserted or a groove or a face for receiving the conductor of the electric wire, and the connecting member is made of the lead-free ultrahigh-conductive plastic.

With this arrangement, as the connecting member is made of the lead-free ultrahigh-conductive plastic and when this connecting member is fitted into the tubular member, the electric connecting device will be produced. Thus it is easy to produce the electric connecting device.

The fourth electric connecting device using resin solder is the first electric connecting device using resin solder, wherein the second connecting part is a wire barrel which crimps the conductor of the electric wire or a slot which displaces the insulation of the electric wire and contacts the conductor thereof, and a part of the wire barrel or the slot which contacts the conductor is made of the lead-free ultrahigh-conductive plastic.

With this arrangement, when the conductor of the electric wire is crimped by the wire barrel or the electric wire is pressed into the slot, the electric wire will be fitted onto the electric connecting device. When the wire barrel or the slot is heated and then cooled, the conductor of the electric wire will be connected to the electric connecting device, and the connecting strength between them will be increased.

The fifth electric connecting device using resin solder is the first electric connecting device using resin solder, wherein the first connecting part is an end of a tongue, a protruding part or a plate, the second connecting part is provided with a face to which the conductor of the electric wire contacts, a hole into which the conductor of the electric wire is inserted, a groove which receives the conductor of the electric wire, or a piercing part which pierces into the electric wire till the conductor is reached, and the entirety is made of the lead-free ultrahigh-conductive plastic.

With this arrangement, when the conductor of the electric wire is made to contact the face of the second connecting part, the conductor of the electric wire is inserted into the hole of the second connecting part or the conductor of the electric wire is received on the groove thereof, the wire will be tacked to the electric connecting device. When the face, the hole or the groove is heated and then cooled, the conductor of the electric wire will be connected to the electric connecting device. Hence the work of connecting the electric wire to the electric connecting device can be done easily. When the piercing part is made to pierce the electric wire, the electric wire will be fitted to the electric connecting device. When the piercing part is heated and then cooled, the conductor of the electric wire will be connected to the electric connecting device and the connecting strength between them will be increased. In these cases, as the first connecting part and the second connecting part have no part which is subjected to a large bending force or the like, no measures will be needed to design the configurations of the respective connecting parts to improve their elasticity. Thus design of the configurations can be easy.

The sixth electric connecting device using resin solder is the fifth electric connecting device using resin solder, wherein a plated layer for increasing the hardness is formed on the surface of the first connecting part. With this arrangement, the surface hardness of the first connecting part is enhanced, and even if it is subjected to frictional forces by, for example, repeated insertion and extraction, the wear will be restrained, and the durability will be improved. Insertion and extraction means inserting or extracting.

The method of connecting an electric wire to the electric connecting device using resin solder is the method of connecting an electric wire to one of the first through sixth electric connecting device using resin solder, and the conductor of the electric wire is placed on the second connecting part of the electric connecting device using resin solder, then electricity is passed between the electric connecting device and the conductor of the electric wire to melt the lead-free solder being contained in the second connecting part and connect the conductor of the electric wire to the electric connecting device. When this method of connecting an electric wire is used, as the second connecting part generates heat by itself, even if it is hard to externally heat the contacting parts between the second connecting part and the conductor of the electric wire, the electric wire will be connected to the electric connecting device.

The first electric connector using resin solder comprises one of the first through sixth electric connecting device using resin solder and an insulating housing for holding the electric connecting device.

An electric wire is connected to the second connecting part of the electric connecting device of this electric connector in a manner similar to the case of the first through sixth electric connecting device using resin solder, and the electric connecting device is coupled with a counterpart member or fitted with a counterpart member by means of the first connecting part. The function in that case is similar to the functions of the first through sixth electric connecting device using resin solder.

The second electric connector using resin solder is the first electric connector using resin solder, wherein the insulating housing is made of a thermoplastic resin, and the electric connecting device and the insulating housing are formed integrally.

With this arrangement, as the electric connector is produced by injection molding or the like, the production efficiency is better in comparison with a case wherein the electric connecting device and the insulating housing are produced separately and then assembled together. Thus this is suited to mass production.

The method of connecting an electric wire to the electric connector using resin solder is the method of connecting an electric wire to the first or second electric connector using resin solder, and the conductor of the electric wire is placed on the second connecting part of the electric connecting device using resin solder, then electricity is passed between the electric connecting device and the conductor of the electric wire to melt the lead-free solder being contained in the second connecting part and connect the conductor of the electric wire to the electric connecting device.

When this method of connecting the electric wire is used, as the second connecting part generates heat by itself, even if it is hard to externally heat the contacting parts of the second connecting part and the conductor of the electric wire, due to, for example, interference by the housing, the electric wire will be connected to the electric connecting device.

What is claimed is:

1. An electric connecting device using resin solder having conductivity,
the electric connecting device comprising a first connecting part which couples with a counterpart member or fits with a counterpart member, and a second connecting part to which a conductor of an electric wire is connected, and
at least a part of the second connecting part to which the conductor of the electric wire is connected is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

2. An electric connecting device using resin solder as recited in claim 1, wherein
the second connecting part is provided with a hole into which the conductor of the electric wire is inserted, a groove which receives the conductor of the electric wire or a piercing part which pierces the electric wire till the conductor thereof is reached, and
at least an inner wall of the hole, a surface layer of the groove or a top end of the piercing part is made of the lead-free ultrahigh-conductive plastic.

3. An electric connecting device using resin solder as recited in claim 2, wherein
the second connecting part is provided with a tubular member, and a connecting member which fits into the tubular member and has a hole into which the conductor of the electric wire is inserted or a groove or a face for receiving the conductor of the electric wire, and
the connecting member is made of the lead-free ultrahigh-conductive plastic.

4. An electric connecting device using resin solder as recited in claim 1, wherein
the second connecting part is a wire barrel which crimps the conductor of the electric wire or a slot which displaces the insulation of the electric wire and contacts the conductor thereof, and
a part of the wire barrel or the slot which contacts the conductor is made of the lead-free ultrahigh-conductive plastic.

5. An electric connecting device using resin solder as recited in claim 1, wherein
the first connecting part is an end of a tongue, a protruding part or a plate,
the second connecting part is provided with a face to which the conductor of the electric wire contacts, a hole into which the conductor of the electric wire is inserted, a groove which receives the conductor of the electric wire, or a piercing part which pierces the electric wire till the conductor is reached, and
the entirety is made of the lead-free ultrahigh-conductive plastic.

6. An electric connecting device using resin solder as recited in claim 5, wherein
a plated layer for increasing the hardness is formed on the surface of the first connecting part.

7. A method of connecting an electric wire to the electric connecting device using resin solder of claim 1, wherein
the conductor of the electric wire is placed on the second connecting part of the electric connecting device using resin solder, then electricity is passed between the electric connecting device and the conductor of the electric wire to melt the lead-free solder being contained in the second connecting part and connect the conductor of the electric wire to the electric connecting device.

8. An electric connector using resin solder comprising
the electric connecting device using resin solder of claim 1, and an insulating housing for holding the electric connecting device.

9. An electric connector using resin solder comprising
the electric connecting device using resin solder of claim 2, and an insulating housing for holding the electric connecting device.

10. An electric connector using resin solder comprising
the electric connecting device using resin solder of claim 3, and an insulating housing for holding the electric connecting device.

11. An electric connector using resin solder comprising
the electric connecting device using resin solder of claim 4, and an insulating housing for holding the electric connecting device.

12. An electric connector using resin solder comprising
the electric connecting device using resin solder of claim 5, and an insulating housing for holding the electric connecting device.

13. An electric connector using resin solder comprising
the electric connecting device using resin solder of claim 6, and an insulating housing for holding the electric connecting device.

14. An electric connector using resin solder as recited in claim 8, wherein
the insulating housing is made of a thermoplastic resin, and
the electric connecting device and the insulating housing are formed integrally.

15. An electric connector using resin solder as recited in claim 9, wherein
the insulating housing is made of a thermoplastic resin, and
the electric connecting device and the insulating housing are formed integrally.

16. An electric connector using resin solder as recited in claim 10, wherein
the insulating housing is made of a thermoplastic resin, and
the electric connecting device and the insulating housing are formed integrally.

17. An electric connector using resin solder as recited in claim 11, wherein
the insulating housing is made of a thermoplastic resin, and
the electric connecting device and the insulating housing are formed integrally.

18. An electric connector using resin solder as recited in claim 12, wherein
the insulating housing is made of a thermoplastic resin, and
the electric connecting device and the insulating housing are formed integrally.

19. An electric connector using resin solder as recited in claim 13, wherein
the insulating housing is made of a thermoplastic resin, and
the electric connecting device and the insulating housing are formed integrally.

20. A method of connecting an electric wire to the electric connector using a resin of claim 8, wherein
the conductor of the electric wire is placed on the second connecting part of the electric connecting device using resin solder, then electricity is passed between the electric connecting device and the conductor of the electric wire to melt the lead-free solder being contained in the second connecting part and connect the conductor of the electric wire to the electric connecting device.
